(19) United States
(12) Patent Application Publication
(10) Pub. No.: US 2025/0362664 A1
(43) Pub. Date: Nov. 27, 2025

(54) Method for Controlling Operation of an Electrolyzer Plant

(71) Applicant: ABB Schweiz AG, Baden (CH)

(72) Inventors: Georg Gutermuth, Heidelberg (DE); Felix Lenders, Darmstadt (DE); Matthias Biskoping, Hirschberg (DE); Bernhard Primas, Mannheim (DE); Eike Fokken, Eppelheim (DE); Katharina Stark, Weinheim (DE)

(73) Assignee: ABB Schweiz AG, Baden (CH)

(21) Appl. No.: 19/296,201

(22) Filed: Aug. 11, 2025

Related U.S. Application Data
(63) Continuation of application No. PCT/EP2024/050886, filed on Jan. 16, 2024.

(30) Foreign Application Priority Data
Feb. 13, 2023 (EP) 23156359

(51) Int. Cl. G05B 19/418

(52) U.S. Cl. CPC G05B 19/41835; G05B 2219/31001

(57) ABSTRACT

A computer-implemented method for controlling operation of an electrolyzer plant comprising one or more electrolyzer modules, each comprising at least one electrolyzer stack, includes determining, for each of the one or more electrolyzer modules, a target module setpoint by minimizing a total operational cost function associated with the operation of the electrolyzer plant, wherein the total operational cost function comprises overall degradation cost associated with the degradation of the one or more electrolyzer modules; and controlling each of the one or more electrolyzer modules to operate at the determined target module setpoint.

### CROSS-REFERENCE TO RELATED APPLICATIONS

The instant application claims priority to International Patent Application No. PCT/EP2024/050886, filed Jan. 16, 2024, and to European Patent Application No. 23156359.4, filed Feb. 13, 2023, each of which is incorporated herein in its entirety by reference.

### FIELD OF THE DISCLOSURE

The present disclosure generally relates to a computer-implemented method for controlling operation of an electrolyzer plant.

### BACKGROUND OF THE INVENTION

Electrolyzer plants comprise one or more electrolyzer modules, each in turn comprising at least one electrolyzer stack. Each stack may consist of a plurality of cells. Improving operation of an electrolyzer plant, particularly operating it at a suitable overall operational setpoint, allows for reducing costs incurred by operating the plant.

Some simple examples for reducing costs include making use of storage for electricity or hydrogen in such a manner as to be able to operate the modules when electricity prices are low. As another example, on a module level, module setpoints may be selected so as to be in power setpoint ranges where the modules operate efficiently.

However, there is a need to make further improvements to control operation of the electrolyzer plants that allow for reducing costs.

### BRIEF SUMMARY OF THE INVENTION

The present disclosure generally describes a computer-implemented method for controlling operation of an electrolyzer plant comprising one or more electrolyzer modules, each comprising at least one electrolyzer stack. The method comprises determining, for each of the one or more electrolyzer modules, a target module setpoint by minimizing a total operational cost function associated with the operation of the electrolyzer plant, wherein the total operational cost function comprises overall degradation cost associated with the degradation of the one or more electrolyzer modules. The method further comprises controlling each of the one or more electrolyzer modules to operate at the determined target module setpoint.

Thus, using the method of the present disclosure, in addition to costs associated with the operation as such, the method also considers costs associated with degradation of the electrolyzer modules. For example, operation at module setpoints may seem to have low costs based on efficiency, pricing of power and hydrogen, or the like, yet may cause undesirable degradation characteristics of the modules, e.g., rapid degradation or unevenly distributed degradation or degradation that causes irregularities in the maintenance schedule.

The method of the present disclosure proposes using a total operation cost function that expresses the total operation cost including degradation cost and minimizing said total cost function. Thus, costs can be reduced compared to known methods. Accordingly, the method of the present disclosure achieves at least the above-identified object.

### BRIEF DESCRIPTION OF THE SEVERAL VIEWS OF THE DRAWING(S)

FIG. 1a is a schematic diagram of an electrolyzer plant in accordance with the disclosure.

FIG. 1b is a schematic diagram of another electrolyzer plant in accordance with the disclosure.

FIG. 2 is a flowchart for a method in accordance with the disclosure.

FIG. 3 is a block diagram for a process in accordance with the disclosure.

FIG. 4 is a block diagram for an additional process in accordance with the disclosure.

### DETAILED DESCRIPTION OF THE INVENTION

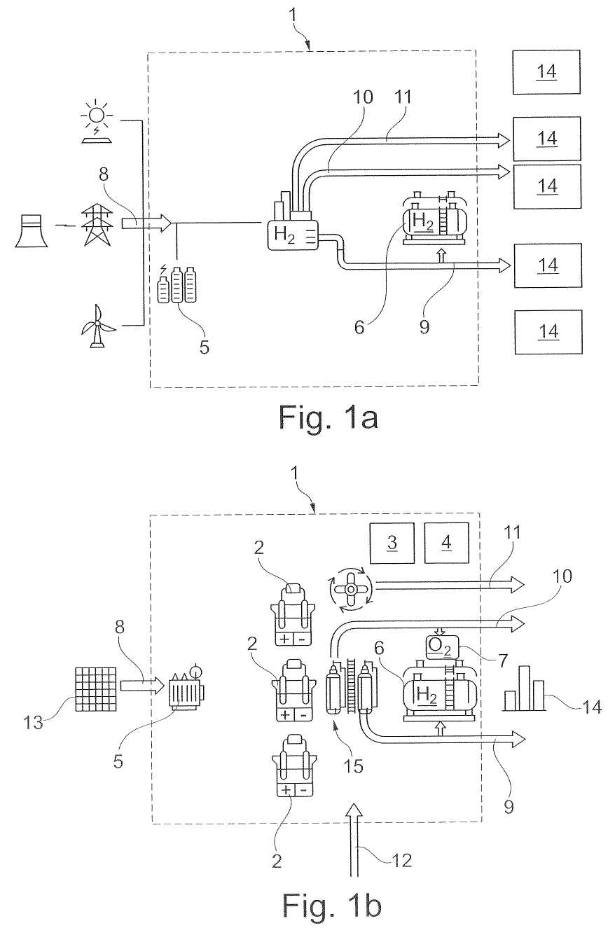

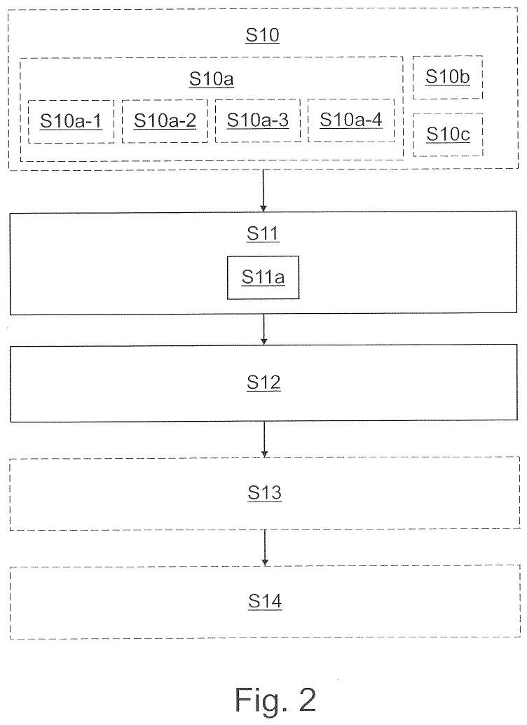

The system 1 of the present disclosure comprises a processing system 3 (also referred to as computing system) configured to carry out a method according to the present disclosure, for example a method as outlined in the context of one of FIGS. 2 to 4. Optionally, the system may also be or comprise an electrolyzer plant comprising a plurality of electrolyzer modules 2. Such a system is illustrated in FIGS. 1a and 1b.

The system in FIGS. 1a and 1b is shown as comprising optional monitoring devices 4, optional electricity storage 5, optional hydrogen storage 6 and optional oxygen storage 7. Furthermore, arrow 8 indicates electricity input to the electrolyzer plant, arrow 9 indicates hydrogen output out of the electrolyzer plant, arrow 10 indicates oxygen output out of the electrolyzer plant, arrow 11 indicates heat output out of the plant (or heat input into the plant), and arrow 12 indicates water input into the electrolyzer plant.

Merely for illustration and not part of the system of the present example, an electrical grid 13 and networks 14 into which the hydrogen, oxygen, and heat are fed, are shown. Moreover, an optional hydrogen and oxygen separator tank 15 is shown.

It is noted that FIG. 1a illustrates the plant with fewer details of the individual components of the plant than in FIG. 1b merely for illustrating in an exemplary manner that different levels of details may be considered when looking at plant operation.

The method of the present disclosure may be performed in a system as shown in FIGS. 1a and 1b, the method steps, for example, being carried out by the processing system 3, or any other suitable system, particularly a system according to the present disclosure.

FIG. 2 is a flowchart illustrating a method according to the present disclosure. The present disclosure provides a computer-implemented method for controlling operation of an electrolyzer plant comprising one or more electrolyzer modules, each comprising at least one electrolyzer stack, particularly, a plant comprising a plurality of electrolyzer modules.

The method comprises determining, in step S11, for each of the one or more electrolyzer modules, a target module setpoint by minimizing, in step S11a, a total operational cost function associated with the operation of the electrolyzer plant, wherein the total operational cost function comprises overall degradation cost associated with the degradation of the one or more electrolyzer modules. Boundary conditions may be set for determining the target module setpoint.

The method also comprises controlling, in step S12, each of the one or more electrolyzer modules to operate at the determined target module setpoint. The method may also comprise the step S10 of determining the total operational cost function prior to step S11.

The step of determining the total operational cost function may comprise determining, in step S10a, for each of the one or more electrolyzer modules, a module degradation cost resulting from operation of the electrolyzer module as a function of module setpoint, and based thereon, determining the overall degradation cost.

The method, particularly determining the total cost function, may comprise one or more of steps S10a-1 to S10a-4.

In optional step S10a-1, the cycle cost is determined based on the number of on/off cycles and the cycle cost for a single cycle, particularly determining the cycle cost by multiplying the number of on/off cycles and the cost of stack maintenance at end-of-life M^{maintenance} divided by the nominal number n^{lifecycle} of on/off cycles before maintenance.

In optional step S10a-2, the ramping cost for operation at a non-constant module setpoint is determined based on cumulative ramping and based on degradation behavior of the electrolyzer module, particularly separator and/or catalyst of the electrolyzer module, depending on the non-constant module setpoint.

The ramping cost, particularly the degradation behavior, may be determined based on the ramping factor r which relates ramping from minimum to maximum module setpoint to one on/off cycle, a ratio of the cumulative ramping and the maximum module setpoint, and cycle cost for a single cycle, particularly the cost of stack maintenance at end-of-life M^{maintenance} divided by the nominal number n^{lifecycle} of on/off cycles before maintenance.

In optional step S10a-3, the degradation cost due to current based on a cumulative current density in the cell membrane is determined, in particular simulated by a model or derived from the module setpoint, or based on an integrated module setpoint, in particular, wherein the degradation cost due to current is determined based on the integrated module setpoint, cost for stack maintenance at end-of-life M^{maintenance}, the nominal stack lifetime, and maximum module setpoint.

In optional step S10a-4, degradation parameters are determined based on stack attributes such as stack type and/or stack supplier.

A detailed example for determining the degradation cost will be provided below. Determining the total operational cost function may comprise the optional step S10b of determining degradation costs associated with use of batteries and/or hydrogen storage as energy storage as part of the operation of the electrolyzer plant. Determining the total operational cost function may comprise the optional step S10c of determining costs associated with a degree of maintenance schedule compliance, for example in the form of an optimization constraint of the like.

The method may comprise the step S13 of monitoring actual module setpoints and corresponding actual degradation and, based thereon, constantly adjusting, in step S14, modelling parameters of a degradation model to reflect the actual degradation under operation at given module setpoints, optionally by means of machine learning, ML, or artificial intelligence, AI.

Examples for methods according to the present disclosure.

The method of the present disclosure describes how to include module degradation/stack degradation into a control/optimization model of a hydrogen production plant via electrolysis. By including degradation in the operational model, the setpoints can be chosen, for example, to minimize the sum of energy cost and stack degradation cost. This leads to setpoint selection resulting in optimized stack lifetime and thus minimized total operational cost.

Electrolyzers, like all electro-chemical machinery (e.g. battery, fuel-cell) degrade with operation over time. This means they lose performance, resulting in efficiency decrease and thus higher power consumption for the same hydrogen production, potentially a higher cross-over (H₂ to O₂ and vice versa) resulting in an increased safety risk, shorter maintenance intervals, leading to more frequent and thus higher stack replacement cost.

At present, electrolysis setpoints are often kept quite constant and close to 100% capacity. For this type of operation, the effect of degradation can be quite well predicted and modelled as a more-or-less linear degradation over time. Consequently, the manufacturers of electrolyzer stacks give a certain amount of “full load operating hours” before a stack must be replaced. This number is typically in the range of 40.000-80.000 hours.

Changes from constant energy supply to a volatile one, for example depending on renewable power availability (sun, wind) have changed the picture. That is, optimizing the operational setpoint depending on market situation (e.g., power spot market) or volatile demand (e.g., trailer loading) may reduce operational cost. However, it may also increase degradation.

Under volatile operations, the lifetime of the stacks may drop dramatically (e.g. by a factor of 2 to 10). Measures for increasing lifetime under volatile conditions are investigated, which are based on changes in production, layout, and materials of the stacks. However, no solutions are currently available for mitigating the effect of volatile operation for existing electrolyzers. The present disclosure proposes mitigating the effect by determining an operational strategy for the electrolyzers, such that benefits can be achieved for existing and future electrolyzers. It is noted that, while beneficial effects of the method of the present disclosure are particularly pronounced for volatile operation scenarios, said beneficial effects are also achieved in non-volatile operation scenarios.

As briefly mentioned above, setpoint optimization is possible, as there are generally flexibilities that give an optimizer alternative choices. Such flexibilities may stem from flexibility in using energy from the grid, flexibility in the amount of output hydrogen, hydrogen storage that acts as a buffer between production and demand and can thus decouple the production setpoints from fixed demand requirements, power storage (e.g., using battery energy storage system, BESS) that acts as a buffer between power supply and the hydrogen production and thus decouples the production setpoints from fixed power availability (e.g. from renewable resources or “power purchase agreements”), and/or availability of multiple electrolyzer modules that allow for distributing the overall plant setpoint, e.g. evenly or differently, to the modules.

The method of the present disclosure allows taking into account degradation effects when determining operational setpoints, specifically module setpoints. A total operational cost function may be used that includes degradation cost. A model may be employed for determining degradation cost, wherein: the model allows to predict the effect under variation of exactly one parameter (i.e., module setpoint); the model allows to predict quantitively the degradation status of the stack, depending on the operational setpoint history; the model can be used in optimization to control, e.g., reduce, degradation; the model depends only on few parameters that can be obtained for each project; the model may provide optimal control of operation of the plant and does not necessarily need to allow for chemical reactions forecasting or degradation status prediction.

As will be understood from the above description, the method of the present disclosure allows to holistically optimize the module setpoints considering module degradation (among other factors). Below an example for determining a total operational cost function including degradation cost is provided in detail.

As an example, as explained above, the following parameters may affect degradation cost (in order of expected severity).

On/Off Cycles (also referred to as open current voltage, OCV, or switching off): Switching an electrolyzer module off and bringing it back to operations dissolves and passivates the electrodes. Only a limited number of such switching cycles can be performed during operations with safety guarantees provided by the module manufacturer and the module has to be maintained or replaced after n^{lifecycles} such switches. This is why it may in same cases be better to keep electrolyzers in “hot standby” where the voltage is below the Nernst Voltage leading to small currents that are flowing, but without any production of hydrogen. However, including it in the model gives the option to still switch off if beneficial and preventing it otherwise.

Set-point ramping (also referred to as volatility): Frequent changes of the setpoints leads to increased degradation. This can very generally be implemented in the control algorithm but making it part of the optimization model ensures that it is only prevented, when advantageous.

Stack temperature: It is known that higher temperatures lead to a quicker chemical reaction. This is true as well for degradation phenomena. On the other hand, higher temperatures lead to increased stack efficiency. Thus, a good balance must be found, which is possible by a model that includes both effects, e.g. as described herein.

High currents (nearly proportional to high power): Stacks running at a higher power may degrade faster. This is why the stack manufacturer may provide their lifetime in terms of “full load hours”, which integrates over time and power.

Considering the above factors, a degradation model to be used for minimizing the total operational cost function can be configured as follows.

On/Off cycles—Cycle cost may be defined as follows (M^{maintenance}=cost of stack maintenance at end-of-life)

$$\begin{matrix}{π}^{cycle degradation , nom} := \frac{{M}^{maintenance}}{{n}^{lifecycles}} number of cycles \\ = \frac{{M}^{maintenance}}{{n}^{lifecycles}}\end{matrix} \qquad \begin{matrix} \\ \\ \{ t ∈ [ 0 , {t}_{f} ] \vert ω ( t - ) = 1 and ω ( t + ) = 0 \} .\end{matrix}$$

Here the number of cycles is counted as the number of times the electrolyzer is switched off and the following abbreviations are used:

$$\begin{matrix}ω ( t - ) = {lim}_{τ \to t , τ < t} ω ( τ ) = \{ \begin{matrix}1 , & module running shortly before t , \\ 0 , & module of shortly before t ,\end{matrix} \\ ω ( t + ) = {lim}_{τ \to t , τ > t} ω ( τ ) = \{ \begin{matrix}1 , & module running shortly before t , \\ 0 , & module of shortly before t ,\end{matrix}\end{matrix}$$

Set-point ramping—Operation at non-constant set-points also leads to degradation behavior of separator and catalyst and can be quantified using

$${\int }_{0}^{{t}_{f}} \vert {\partial }_{t} {P}^{D C} ( t ) \vert dt$$

To relate this quantity to a penalty, the ramp degradation is compared to cycle degradation, where we assume that operating a ramp from minimal to maximal power set-point has the same degrading effect as r off/on cycles, where r is a ratio between 0 (0%) and 1 (100%). Then

$${π}^{ramp degradation , nom} := \frac{{rM}^{maintenance}}{{n}^{lifecycles} {P}_{max}^{D C}} {\int }_{0}^{{t}_{f}} \vert {\partial }_{t} {P}^{D C} ( t ) \vert dt$$

High currents-Operation at higher currents leads to higher degradation due to anode passivation, growth of inhibiting structures and thinning of separator. To measure the operation at high currents, weighted with the time an electrolyzer module is operated at such high currents, the quantity

$${\int }_{0}^{{t}_{f}} j ( t ) d t$$

can be used. Here j denotes the current density in the cell membrane. The current density j is typically only available within high detail physical simulations but is monotonically correlated with the power of an electrolyzer module. As a surrogate that is available also in simple models such as the presented linear model, the integrated power may be used:

$${\int }_{0}^{t} {P}^{D C} ( t ) d t$$

A degradation cost may be attributed to this quantity in the following way: If a module is operated for the time T^{lifespan} at the maximal power set-point is has to undergo maintenance with maintenance cost M^{maintenance}. Thus

$${π}^{power degradation , nom} := \frac{{M}^{maintenance}}{{P}_{max}^{D C} {T}^{lifespan}} {\int }_{0}^{{t}_{f}} {P}^{D C} ( t ) dt .$$

Temperature—The aforementioned effects are generally temperature dependent. They increase with higher module temperature and decrease with lower temperature. The above relations are valid for electrolyzer module operation at nominal temperature T^{nom}. For temperatures different from nominal operation temperature, they are rescaled, for example with a factor described by Arrhenius law

$$exp ( \frac{E}{R} ( \frac{1}{T} - \frac{1}{{T}^{n o m}} ) ) .$$

Here R denotes the universal gas constant and E is the activation energy of the degradation reaction.

Total model—Combining the mentioned degradation effects into a single degradation penalty yields

$${π}^{degradation} = exp ( \frac{E}{R} ( \frac{1}{T} - \frac{1}{{T}^{n o m}} ) ) [ {π}^{power degradation , nom} + {π}^{cycle degradation , nom} + {π}^{ramp degradation , nom} ] .$$

This equation captures all four mentioned effects and only relies on the following parameters:

| | Description | Origin | Value example | |
|---|---|---|---|---|
| E | Activation energy of the | e.g. from measurements | E/R = 0.07226 | K |
| | degradation reaction | | | |
| T^{nom} | Temperature of stack | e.g. provided by stack supplier | 80° | C. |
| | during nominal operation | | | |
| T^{lifespan} | Stack lifetime under | e.g. provided by stack supplier | 50.000 full-load- | |
| | nominal operation | | hours | |
| P^{DC}ₘₐₓ | Maximum DC power | e.g. provided by stack supplier | 1 | MW |

| | | | |
|---|---|---|---|
| | setpoint | | |
| M^{maintenance} | Cost for stack maintenance | e.g. provided by stack supplier | 50% of new stack |
| n^{lifecycle} | Number of on/off cycles | e.g. provided by stack supplier | 500 |
| | before maintenance | | |
| r | Factor that relates one | e.g. from measurements | 10% |
| | “ramping from min to | | |
| | max” to one “on/off cycle” | | |

Determine setpoint based on minimization of total operational costs—The combined degradation penalty is used to compute the module setpoints. In general, using optimization to obtain module setpoints may yield an optimization problem of the form

$${min}_{x , y} E ( x , y ) s . t . c ( x , y ) \geq 0 , y binary$$

where x, y denote decision variables and x comprises at least the module points of the individual modules on a time-grid, i.e.

$$x = ( {P}_{1}^{1} … {P}_{{n}^{step}}^{1} , {P}_{1}^{2} … {P}_{{n}^{step}}^{2} , … {P}_{1}^{{n}^{modules}} , … , {P}_{{n}^{step}}^{{n}^{modules}} , further decision variables , … ) .$$

### Here

$${P}_{j}^{i}$$

denotes the DC power set-point of the i-th electrolyzer module in the j-th timestep. Furthermore c(x, y)≥0 encodes the operational model of the hydrogen production plant and E(x, y) the energy cost associated with the module setpoints encoded by x over the time-horizon.

To include degradation into the model is to compute module setpoints by instead optimizing

$${min}_{x , y} E ( x , y ) + {π}^{degradation} ( x , y ) s . t . c ( x , y ) \geq 0 , y binary$$

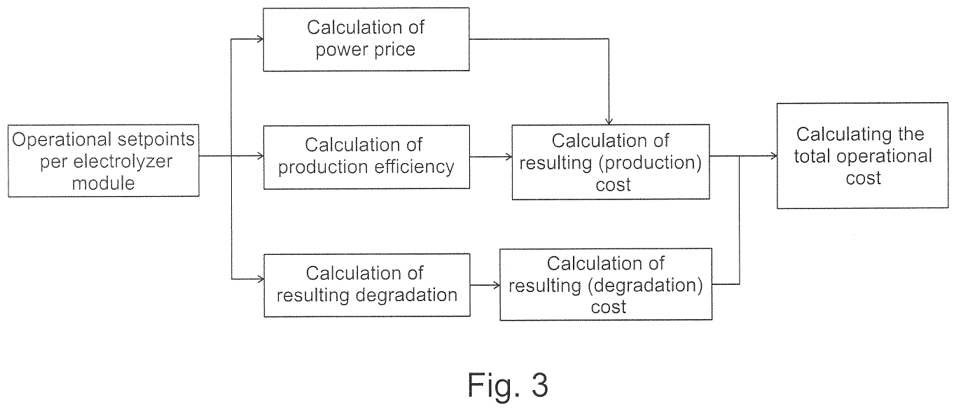

An exemplary flowchart for a method according to the present disclosure, which may employ the above principles, is shown in FIG. 3. It is noted that it is not necessary to include all of the above factors when determining the cost function. An improvement is already achieved when taking into account at least one of them. In some practical cases some factors may not have a significant impact. In any case, an accuracy of the method may be further improved by taking into account more than one of the factors.

Further aspects of the present disclosure.

According to the present disclosure, the cost function may take into account degradation parameters that depend on stack attributes, among others the type of the stack (PEM, alkaline, SOEC, . . . ) and/or the supplier.

According to the present disclosure, the method may entail, in the determination of the module setpoints, optimized usage of storage assets for power and/or hydrogen.

The method may entail, in the determination of the module setpoints, taking into account battery degradation for electrical energy storage so as to prevent excessive battery degradation.

The method may entail, as secondary goals or boundary conditions for the minimization, controlling degradation of the electrolyzer modules, for example to minimize degradation or to meet maintenance schedules, e.g., to improve spare part management and maintenance schedule compliance. The latter may entail controlling operation to achieve Quicker degradation to ensure that the stack is at end-of-life when the planned replacement date is scheduled, and Slower degradation to ensure that the stack will still be operational and safe until the planned replacement date.

According to the method of the present disclosure, actual module setpoints may be stored, the real degradation may be monitored, and the model parameters of the above-described model(s) may be constantly adjusted/updating to reflect the actual degradation under given setpoints. This can be done with AI or ML. This may enhance accuracy because the degradation parameters usually vary between individual electrolyzer stacks and because the real degradation usually follows a non-linear behavior of degradation over time. The proposed method may take care that always a local linear fit to the degradation curve at the current time is taken.

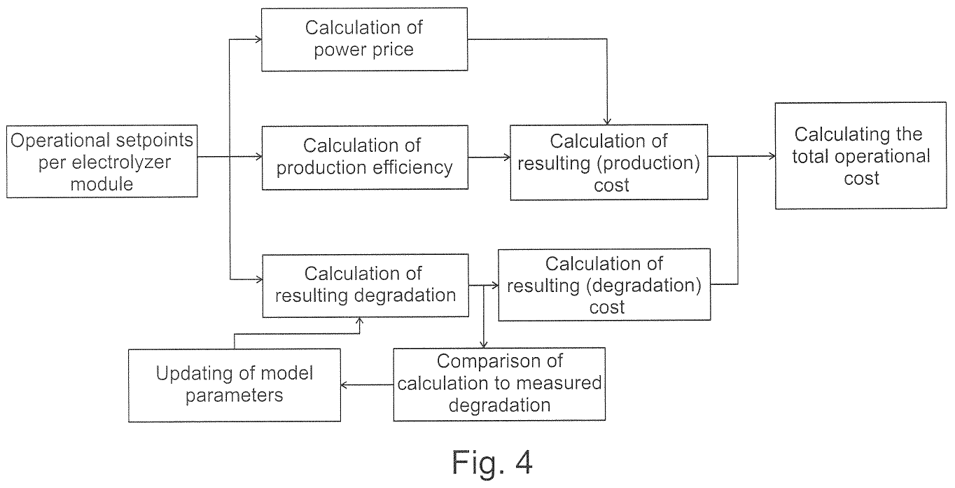

FIG. 4 illustrates an exemplary workflow including such as adjusting or updating of model parameters.

The method of the present disclosure has been shown to decrease total operational cost. The total operational cost has been shown to be decreased by about 2% for some relatively constant operation scenarios and about 35% for some rather volatile operation scenarios, as compared to degradation-unaware control.

In the context of the present disclosure, the electrolyzer plant may comprise a plurality of electrolyzer modules. Each of the electrolyzer modules may comprise a plurality of stacks. Each stack may comprise a plurality of cells.

An electrolyzer module may comprise, in addition to one or more stacks, other components, e.g., separator tanks, cooling units, pumps, a rectifier and/or a filter.

In the present disclosure, a setpoint may be a value that is representative of the power at which an electrolyzer module is operated at a given point in time. This is also referred to as power setpoint of the electrolyzer module. A (module) setpoint may, for example, be expressed as a power value, a current value, or a voltage value. The module setpoint, as an example, may determine the current running through the stacks of the module.

The term “target module setpoint” may be understood broadly and may, for example, refer to an operational parameter to be set for the operation of the electrolyzer module.

Operating an electrolyzer module at the determined target setpoint may comprise setting the target setpoint as a control parameter for the operation of the electrolyzer module.

A (power) setpoint of an electrolyzer plant may be the sum of the (power) setpoints of all electrolyzer modules of the plant. All modules may operate at the same setpoint or the setpoints of different modules may be different.

An electrolyzer module operation may also be described by a hydrogen setpoint, which is the hydrogen output by an electrolyzer module. Similarly, the electrolyzer plant may have an overall plant hydrogen setpoint. The overall plant hydrogen setpoint may equal the sum of the module hydrogen setpoints or may differ from said sum, e.g., when hydrogen is fed into or taken from hydrogen storage.

The total operational cost function, according to the present disclosure, may be a function that represents overall operational cost as a function of the module setpoints plus additional aspects by plant-wide functionality, the so-called BoP (Balance of Plant includes among others water cleaning, hydrogen drying, compression and storage, electrical distribution, and plant automation.

The total operational costs (as will be described in more detail below) may, in addition to overall degradation cost associated with the degradation of the one or more electrolyzer modules, comprise other costs associated with operation of the electrolyzer plant, for example energy cost, energy storage cost, cost associated with the hydrogen price, hydrogen storage cost, cost associated with energy storage degradation and losses, cost associated with hydrogen storage degradation and losses, or the like.

The overall (module) degradation cost and said other costs may each be seen as a term of the total operational cost function.

The overall degradation cost associated with the degradation of the one or more electrolyzer modules may comprise any cost arising due to degradation of an electrolyzer, for example, cost associated with degradation being above or below an ideal degradation rate, maintenance costs, module exchange costs, or the like. The overall degradation cost may be a sum, optionally a weighted sum, of the respective module degradation cost of each of the modules.

The module degradation cost and how it may be determined will be described in more detail below. The module degradation cost may be provided as a function of module setpoint, i.e., module degradation cost may depend on the setpoint at which an electrolyzer module is operated.

The method of the present disclosure may comprise the step of determining the total operational cost function. Determining the total operational cost function may comprise determining, for each of the one or more electrolyzer modules, a module degradation cost resulting from operation of the electrolyzer module as a function of module setpoint and/or module setpoint variations. Determining the total operational cost function may further comprise, based on the determined module degradation cost, determining the overall degradation cost.

Thus, a predictive component is introduced in the total operational cost function that allows for projecting future costs due to module degradation.

According to the present disclosure, the module degradation cost may be calculated based on at least one of the following: cycle cost, in particular based on a number of on/off cycles for the electrolyzer module, ramping cost, in particular based on a cumulative amount of module setpoint ramping for the electrolyzer module, degradation cost due to current, in particular based on cumulative current or current density for the electrolyzer module, operating temperature, in particular, a scaling factor derived from the operating temperature, for example, described by Arrhenius law.

The term cycle cost is to be understood broadly and may refer to the cost brought about by switching on and off an electrolyzer module. Each switching cycle (or on/off cycle) leads to dissolving and passivation of electrolyzer electrodes. The cycle cost depends on several on/off cycles for the electrolyzer module, for example increase linearly with the number of on/off cycles. Thus, as an example, to reduce the degradation rate, it may be advantageous to keep the electrolyzer module in an on-state (i.e. at a module setpoint that is not zero) or at least hot standby.

The term ramping cost is to be understood broadly and may refer to cost associated with changing the module setpoint in operation, i.e., setpoint ramping. Ramping may, for example, affect the separator and the catalyst of an electrolyzer module. The ramping cost may be based on a cumulative amount of module setpoint ramping for the electrolyzer module, e.g., a time integrated module setpoint ramping.

The term “degradation cost due to current” is to be understood broadly and may refer to cost associated with degradation due to currents during operation, particularly due to high currents, which degrade modules faster than lower currents. The degradation cost due to current may be based on cumulative current or current density for the electrolyzer module, e.g., a time integrated current or current density.

The term operating temperature is to be understood broadly and may refer to a temperature of a module during operation. Higher temperature may increase the speed of chemical reactions, including degradation reactions. This particularly concerns operation temperatures above a nominal operation temperature, e.g., provided by a manufacturer. The module degradation cost may, for example, be calculated by using a scaling factor derived from the operating temperature, for example, described by Arrhenius law.

The module degradation cost may be based on at least one of the following parameters, one or more of which may be time dependent, associated with the at least one stack of the electrolyzer module: activation energy E of degradation reaction, nominal temperature of the stack T^{nom}, nominal stack lifetime T^{lifetime} maximum stack current Iₘₐₓ, cost for stack maintenance M^{maintenance} at end-of-life, nominal number n^{lifecycle} of on/off cycles before stack maintenance, ramping factor r, which relates ramping from minimum to maximum module setpoint to one on/off cycle.

The activation energy E of the degradation reaction may, for example, be determined empirically or semi-empirically or modelled. The nominal temperature of the stack T^{nom} refers to a temperature of the stack during nominal operation. It may, for example, be provided by the stack supplier. The nominal stack lifetime T^{lifetime} may refer to a stack lifetime under nominal operation, e.g., in terms of full load hours, and may be provided by a stack supplier. The maximum stack current Iₘₐₓ may refer to the maximum current at which the module is operated. The cost for stack maintenance M^{maintenance} at end-of-life may be the cost for module maintenance by cell replacement and may be provided by a stack supplier. The nominal number n^{lifecycle} of on/off cycles before stack maintenance may be a value provided by the supplier. The ramping factor r, which relates ramping from minimum to maximum module setpoint to one on/off cycle may, for example, be determined empirically, semi-empirically or modelled.

At least some of the above parameters may be time dependent. In particular, the parameters, particularly the ramping factor r, may change over the course of the stack lifetime. Accordingly, maintenance costs may also change over time.

The method of the present disclosure may comprise determining the cycle cost based on the number of on/off cycles and the cycle cost for a single cycle, particularly determining the cycle cost by multiplying the number of on/off cycles and the cost of stack maintenance at end-of-life M^{maintenance} divided by the nominal number n^{lifecycle} of on/off cycles before maintenance. Reducing the number of cycles may decrease a degradation rate, for example.

The method of the present disclosure may comprise determining the ramping cost for operation at a non-constant module setpoint based on cumulative ramping and based on degradation behavior of the electrolyzer module, particularly separator and/or catalyst of the electrolyzer module, depending on the non-constant module setpoint. Reducing the cumulative (integrated over time) ramping of the module setpoint may decrease the degradation rate of the electrolyzer module. The non-constant module setpoint, may, for example, be expressed by P(t), U(t), or I(t).

According to the present disclosure, the ramping cost, particularly the degradation behavior, may be determined based on a/the ramping factor r which relates ramping from minimum to maximum module setpoint to one on/off cycle, a ratio of the cumulative ramping and the maximum module setpoint, and cycle cost for a single cycle. The cost for a single cycle may be the cost of stack maintenance at end-of-life M^{maintenance} divided by the nominal number n^{lifecycle} of on/off cycles before maintenance.

The method of the present disclosure may comprise determining the degradation cost due to current based on a cumulative current density in the cell membrane, in particular simulated by a model or derived from the module setpoint or based on an integrated module setpoint. In particular, the degradation cost due to current may be determined based on the integrated module setpoint, cost for stack maintenance at end-of-life M^{maintenance}, a/the nominal stack lifetime, and maximum module setpoint. Reducing the cumulative current may decrease a degradation rate, for example.

The method of the present disclosure may comprise determining the total operational cost function and determining the total operational cost function may comprise at least one of: determining degradation parameters based on stack attributes such as stack type and/or stack supplier, determining degradation costs of energy storages associated with use of hydrogen storage and/or batteries as energy storage as part of the operation of the electrolyzer plant, determining costs associated with a degree of maintenance schedule compliance. Alternatively, or in addition, determining the target module setpoints may be carried out with maintenance schedule compliance as constraints.

Degradation at a certain rate also impacts factors other than, e.g., production efficiency and/or replacement costs for the module, i.e., immediate costs associated with degradation. For example, maintenance schedules for the electrolyzer plant may be in place, having been determined based on expected degradation rates of the modules. Modules degrading faster or slower than this expected degradation rate may increase maintenance cost. It may also lead to modules being exchanged before or after they reach a degradation state at which they should be exchanged. Moreover, hydrogen production efficiency (and, accordingly, production costs) may depend on the degradation state of an electrolyzer module.

Determining degradation parameters based on stack attributes such as stack type and/or stack supplier may comprise taking into account nominal values for one or more of the above parameters associated with the stack(s) of a given module.

Determining costs associated with a degree of maintenance schedule compliance may comprise determining costs that arise when modules are fully degraded prior to a scheduled maintenance time or are not fully degraded at the scheduled maintenance time, e.g., being short of a module for some time, additional maintenance action, or taking a module out of operation sooner than necessary.

Carrying out determining the target module setpoints with maintenance schedule compliance as constraints may comprise, as an example, setting constraints such that certain modules will reach a maintenance state at a predetermined time based on expected degradation.

According to the present disclosure, the module degradation cost may be predicted using a model configured to quantitatively determine the degradation of the at least one electrolyzer stack depending on module setpoint history. As an example, the model may take into account one or more of the above-mentioned parameters associated with module degradation cost.

The method of the present disclosure may comprise monitoring actual module setpoints and corresponding actual degradation and, based thereon, constantly adjusting model parameters of the model to reflect the actual degradation under operation at given module setpoints, optionally by means of machine learning, ML, or artificial intelligence, AI. Thus, a corrective element is provided that allows for improved prediction accuracy of the degradation costs, and, accordingly, better results in terms of cost reduction.

According to the present disclosure, determining the target module setpoints may be carried out such that the target module setpoint is the same for all electrolyzer modules. For example, this may be achieved by a corresponding boundary condition. This can have computational benefits, automation necessity, e.g. if modules cannot be controlled individually, or the wish to evenly wear the stacks. The overall plant power setpoint may result from a sum of the module setpoints of all (active) electrolyzer modules of the plant. Thus, the overall plant power setpoint may be distributed evenly over the plurality of electrolyzer modules.

Determining the target module setpoints may comprise taking into account constraints concerning the plant setpoint. For example, a plant setpoint, although governed by some constraints (e.g., sufficient output of the plant from operation and storage and/or limits to the amount of consumed electricity for operation), may be varied within said constraints. For example, flexibility may be provided by hydrogen or electricity storage, as mentioned above.

The operation of the plant may, for example, be characterized at least by input power and a hydrogen output and/or an efficiency of hydrogen production of the overall plant. Additional parameters characterizing the operation are conceivable.

Moreover, further aspects may also be considered in the optimization, e.g., available storage for energy, hydrogen, oxygen, and heat, and their respective cost/efficiency.

Further aspects that may also be considered in the optimization are characteristics of the electrolyzer modules, operating conditions, or wear of equipment, among others.

Optionally, in addition to the above-described technical aspects, there may also be aspects that concern pricing, contractual obligations, or the like, that can be considered in the optimization.

The invention also provides a system comprising a processing system configured to carry out any of the methods of the present disclosure.

The system may further comprise one or more electrolyzer modules of an electrolyzer plant, the processing system configured to control operation of the one or more electrolyzer modules to operate at the determined target module setpoints. The system may be or comprise the electrolyzer plant.

The system may comprise a hydrogen storage system and/or a power storage system.

The invention also provides a computer program product comprising instructions which, when the program is executed by a computer, cause the computer to carry out any of the methods of the present disclosure.

The invention also provides a computer-readable medium comprising instructions which, when executed by a computer, cause the computer to carry out any of the methods of the present disclosure.

The features and advantages outlined above in the context of the method similarly apply to the system, the computer program product, and the computer-readable medium described herein.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A computer-implemented method for controlling operation of an electrolyzer plant comprising one or more electrolyzer modules, each comprising at least one electrolyzer stack, the method comprising:
determining, for each of the one or more electrolyzer modules, a target module setpoint by minimizing a total operational cost function associated with the operation of the electrolyzer plant, wherein the total operational cost function comprises overall degradation cost associated with the degradation of the one or more electrolyzer modules; and
controlling each of the one or more electrolyzer modules to operate at the determined target module setpoint.

2. The method of claim 1, further comprising determining a total operational cost function, wherein determining the total operational cost function comprises determining, for each of the one or more electrolyzer modules, a module degradation cost resulting from operation of the electrolyzer module as a function of module setpoint and/or setpoint variations, and, based thereon, determining the overall degradation cost.

3. The method of claim 2, wherein the module degradation cost is calculated based on at least one of the following:
cycle cost based on more than one on/off cycle for the electrolyzer module,
ramping cost based on a cumulative amount of module setpoint ramping for the electrolyzer module,
degradation cost due to current based on cumulative current or current density for the electrolyzer module, and
a scaling factor derived from an operating temperature.

4. The method of claim 2, wherein the module degradation cost is based on at least one of the following parameters, one or more of which may be time dependent, associated with the at least one stack of the electrolyzer module:
activation energy E of degradation reaction,
nominal temperature of the stack,
nominal stack lifetime,,
maximum stack current Iₘₐₓ,
cost for stack maintenance M^{maintenance} at end-of-life,
nominal number n^{lifecycle} of on/off cycles before stack maintenance, and
ramping factor r, which relates ramping from minimum to maximum module setpoint to one on/off cycle.

5. The method of claim 3, further comprising determining the cycle cost based on the number of on/off cycles and the cycle cost for a single cycle, particularly determining the cycle cost by multiplying the number of on/off cycles and the cost of stack maintenance at end-of-life M^{maintenance} divided by the nominal number n^{lifecycle} of on/off cycles before maintenance.

6. The method of claim 3, further comprising determining the ramping cost for operation at a non-constant module setpoint based on cumulative ramping and based on degradation behavior of the electrolyzer module depending on the non-constant module setpoint.

7. The method of claim 6, wherein a degradation behavior of the ramping cost is determined based on a ramping factor r that relates to ramping from a minimum to a maximum module setpoint during one on/off cycle, a ratio of a cumulative ramping and the maximum module setpoint, and a cost of stack maintenance at end-of-life M^{maintenance} divided by the nominal number n^{lifecycle} of on/off cycles before maintenance.

8. The method of claim 3, further comprising determining the degradation cost due to current based on a cumulative current density in a cell membrane, which is simulated by a model. derived from the module setpoint, or is based on an integrated module setpoint;
wherein the degradation cost due to current is determined based on the integrated module setpoint, cost for stack maintenance at end-of-life M^{maintenance}, a nominal stack lifetime, and the maximum module setpoint.

9. The method of claim 1, further comprising determining the total operational cost function, wherein determining the total operational cost function comprises at least one of: determining degradation parameters based on stack attributes such as stack type and/or stack supplier, determining degradation costs associated with use of batteries and/or hydrogen storages as energy storage as part of the operation of the electrolyzer plant, and determining costs associated with a degree of maintenance schedule compliance, and/or wherein determining the target module setpoints is carried out with maintenance schedule compliance as constraints.

10. The method of claim 2, wherein the module degradation cost is predicted using a model configured to quantitatively determine the degradation of the at least one electrolyzer stack depending on module setpoint history.

11. The method of claim 10, wherein actual module setpoints and corresponding actual degradation are monitored and, based thereon, model parameters of the model are constantly adjusted to reflect the actual degradation under operation at given module setpoints.

12. The method of claim 1, wherein determining the target module setpoints is carried out such that the target module setpoint is the same for all electrolyzer modules.

13. A system, comprising:
a processing system, the processing system configured to carry out a method for controlling operation of an electrolyzer plant comprising one or more electrolyzer modules, each comprising at least one electrolyzer stack, the method comprising:
determining, for each of the one or more electrolyzer modules, a target module setpoint by minimizing a total operational cost function associated with the operation of the electrolyzer plant, wherein the total operational cost function comprises overall degradation cost associated with the degradation of the one or more electrolyzer modules; and
controlling each of the one or more electrolyzer modules to operate at the determined target module setpoint;
one or more electrolyzer modules of an electrolyzer plant, wherein the processing system is configured to control operation of the one or more electrolyzer modules to operate at determined target module setpoints; and
a hydrogen storage system and/or a power storage system.
